(19) United States
(12) Patent Application Publication
(10) Pub. No.: US 2011/0100313 A1
(43) Pub. Date: May 5, 2011

(54) REDUCTION OF WEAR IN COMPRESSION IGNITION ENGINE

(75) Inventor: Gareth Floweday, Cape Town (ZA)

(73) Assignee: SASOL TECHNOLOGY (PTY) LTD, Rosebank, Johannesburg (ZA)

(21) Appl. No.: 12/996,109

(22) PCT Filed: Jun. 5, 2009
(86) PCT No.: PCT/ZA09/00052

§ 371 Date: Dec. 3, 2010

(30) Foreign Application Priority Data
Jun. 6, 2008 (ZA) 2008/4940

(51) Int. Cl. F02B 1/00

(52) U.S. Cl. 123/1 A; 123/304

(57) ABSTRACT

The invention relates to a method of operating a compression ignition engine. According to the invention, the engine is operated with a Fischer-Tropsch derived fuel containing composition to reduce wearing of the engine cylinder walls compared to operating the engine with petroleum derived fuel.

### FIELD OF THE INVENTION

This invention relates to reduction of wear in a compression ignition engine system.

### BACKGROUND OF THE INVENTION

Gradual wear takes place in many locations within a diesel engine. Iron contamination in engine lubricant oil is most commonly an indication of wear of the cylinder walls. Wear of the cylinder walls can be caused by the individual or combined modes of corrosion, adhesion and abrasion wear mechanisms as follows:

Corrosion wear on cylinder walls is caused by the formation of acidic substances either in the oil film or directly on the metal surface. This is usually associated with the levels of sulphur contained in the fuel and subsequent formation of sulphur oxides and sulphuric acid in the combustion products.

Adhesive wear on cylinder walls typically takes place on engine start-up, due to insufficient oil between the piston rings and cylinder walls

Abrasive wear occurs on cylinder walls due to the presence of abrasive debris in the protective oil film which separates lubricated parts. This debris can be atmospheric dust and/or metallic debris from corrosive and adhesive wear.

Piston ring and cylinder liner wear in diesel engines have been shown by Nagaki and Korematsu (Effect of Sulphur Dioxide Added to Induction Air on Wear Of Diesel Engine, SAE 930994, Kogakuin University) to be strongly linked to induced sulphur levels. The mechanism of wear was assumed to be a combination of corrosion due to formation of sulphuric acid in the oil film as well as abrasion caused by the formation of sulphates in the oil film. Interestingly, the increased wear rates due to sulphur dioxide addition were observed instantly and directly even though the lubrication oil additives effectively neutralised the acidic components in the sump volume.

Use of cooled Exhaust Gas Recirculation (EGR) results in increased piston ring and cylinder liner wear according to a study by Takakura et al. (The Wear Mechanism of Piston rings and Cylinder liners Under Cooled-EGR Condition and the Development of Surface Treatment Technology for Effective Wear reduction, SAE 2005-01-1655, Hino Motors Ltd). Using a combination of post engine test evaluation techniques, it was identified that the wear mechanism occurs as follows: exhaust gas cooling (cooled EGR), sulphuric acid condensation, formation of aqueous sulphuric acid in oil film, corrosive wear (preferential corrosion around the steadite) on the liner surface, removal of steadite, abrasive wear.

Total Base Number (TBN) depletion and soot loading has been shown by Froelund and Ross (Laboratory Benchmarking of Seven Model Year 2003-2004 Heavy Duty Diesel Engines Using a Cl-4 Lubricant, SAE 2005-01-3715) to be not significantly increased by EGR although iron wear rates were significantly greater for the engines in this study with EGR. It was concluded that differences in engine wear seen in the study was not directly linked with EGR. The reasons for the higher wear rates were not fully explained.

Wear has been shown by Kim et al. (Relationships among Oil composition Combustion-Generated Soot and Diesel Engine Valve Train Wear, SAE 922199, General Motors Research and Environmental Labs) to increase with increased soot concentration, decreased dispersant concentration and decreasing sulphur concentrations in the oil.

Soot was found by Mainwaring (Soot and Wear in Heavy duty Diesel Engine, SAE 971631, Shell Additives International Ltd) to be pro-wear only in cases where particle size exceeded oil film thickness. Dispercency additives were found to have a greater effect on wear due to viscosity and associated film thickness effects than soot agglomeration control.

Engines have been shown by Truhan et al. (The Classification of Lubricating Oil contaminants and their effect on wear in diesel engines as measured by surface layer activation, SAE 952558, Fleetguard Corp) to be quite tolerant of wear debris build-up as long as threshold levels required to accelerate wear were avoided. Organic contamination including sludge and oxidation products did not seem to be abrasive, but did have a pronounced effect on increasing viscosity. Measured soot did not correlate well with increased wear, but it was thought that the measurement might have been skewed by organic decomposition rather than measuring actual fuel combustion generated soot. Hard particle contamination only resulted in wear once threshold levels of concentration and particle size were exceeded. This threshold was thought to be different with different engines and associated oil film thicknesses.

### OBJECTS OF THE INVENTION

It is an object of the present invention to provide a method of operating a compression ignition engine thereby further reducing wearing as compared to the prior art measures described above.

It is also an object of the present invention to provide a new method of operating a compression ignition engine involving an inventive step.

### SUMMARY OF THE INVENTION

Fischer Tropsch (FT) diesel is a low sulphur, low aromatic fuel comprising mainly paraffins derived from the Fischer Tropsch process. The Fischer Tropsch process has been described extensively in the technical literature, for example in Fischer Tropsch Technology, edited by AP Steynberg and M Dry and published in the series Studies in Surface Science and Catalysis (v.152) by Elsevier (2004).

According to a first aspect of the invention, there is provided a method of operating a compression ignition (Cl) engine with a Fischer-Tropsch derived fuel containing composition to reduce wearing of the engine cylinder walls compared to operating the engine with petroleum derived fuel.

The engine may have a compression ratio of greater than 14:1, typically in excess of 16:1, in one embodiment 18:1.

The engine may be turbocharged at a boost of from 0 to 2 bar above atmosphere, typically from 0 to 1.5 bar above atmosphere.

The engine oil operating temperature may be between 30 degC and 150 degC, typically between 40 and 130 degC.

The fuel composition may include from 1 vol % to 100 vol % Fischer Tropsch fuel.

The fuel composition may include from 50 vol % to 100 vol % Fischer Tropsch fuel.

The Fischer-Tropsch fuel may have <0.1 mass % aromatics, <0.1 mass % sulphur, cetane above 65, and density below 0.8 kg/l, generally below 0.01 mass % sulphur, and typically below 0.001 mass % sulphur.

The petroleum derived fuel with which comparison is being made may have <0.1 mass % sulphur, generally below 0.01 mass % sulphur, and typically below 0.002 mass % sulphur.

The fuel composition may have a lower flame luminosity than petroleum derived low sulphur diesel when combusted in a Cl engine.

The fuel composition may reduce the amount of soot loading in the engine oil when compared to the engine operating on petroleum derived fuel.

The method may reduce the iron contamination rate in engine oil by up to 46% compared to low sulphur petroleum derived diesel.

The method may reduce the iron contamination rate in engine oil by 37% compared to low sulphur petroleum derived diesel.

The method may reduce the iron contamination rate in engine oil by 22% compared to low sulphur petroleum derived diesel.

The method may reduce iron contamination rate in engine oil by between 22 to 46% compared to low sulphur petroleum derived diesel fuel.

The reduced wear rates were achieved during a 1000 hour endurance test where the engine did 1800 repetitions of a 33 min 20 sec cycle. In each cycle the engine operating conditions were varied throughout its capable range:
Speed varied between idle (780 rpm) and full speed (4600 rpm) and there was a short period of stationary time.
Load varied between zero (at idle) and full load (torque=340 Nm)
The engine has a compression ratio of 18:1
The engine is turbocharged and intercooled—the boost varies between zero and 1.4 bar above atmospheric (approx 2.4 bar absolute pressure)
The engine coolant temperature varied between 40 and 95 degrees C.
The engine oil temperature varied between 40 and 130 degrees C.

### DESCRIPTION OF EXAMPLES OF THE INVENTION

The invention will now be described, by way of non-limiting examples only, with reference to the accompanying drawings, in which:

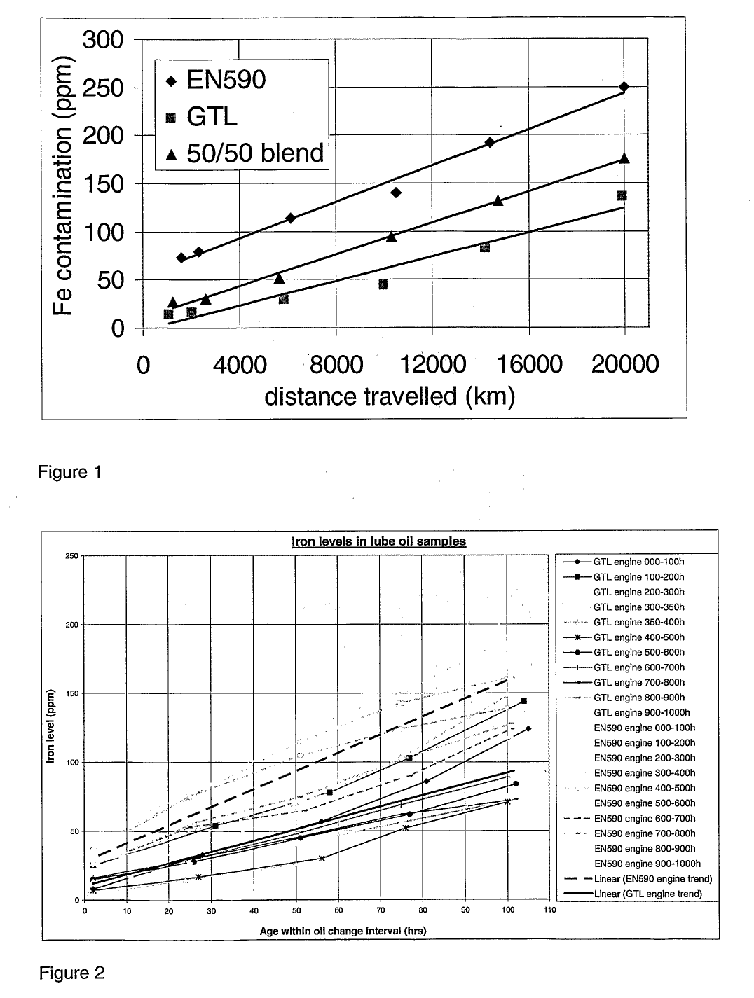

FIG. 1 diagrammatically shows iron contamination data against traveled distance for various fuel compositions applied to a passenger car fleet;

FIG. 2 diagrammatically shows iron contamination data from bench dynamometer endurance tests for various fuel compositions;

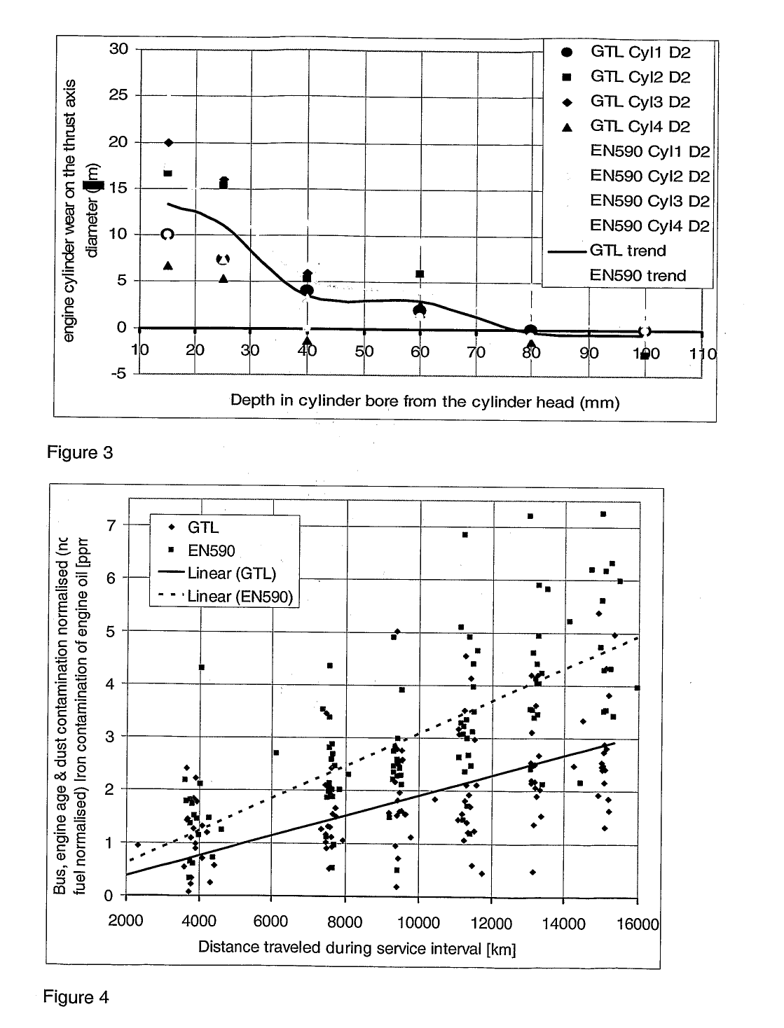

FIG. 3 diagrammatically shows cylinder bore wear measurements on the thrust axes in engines for various fuel compositions;

FIG. 4 diagrammatically shows normalised iron contamination data against traveled distance for various fuel compositions applied to a bus fleet;

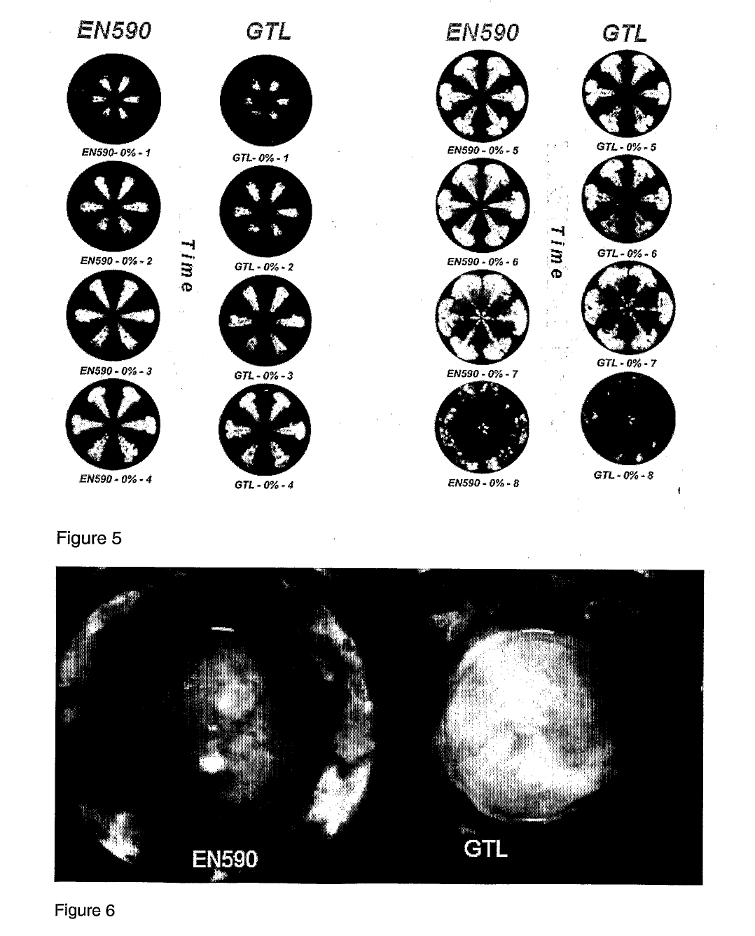

FIG. 5 schematically shows images of combustion in a constant volume bomb of two different fuel compositions; and

FIG. 6 schematically shows images of combustion in a quartz-piston engine of two different fuel compositions.

In all drawings, like reference numerals refer to like parts, unless otherwise indicated. In the following, three different fuels are used to operate vehicles. Parameters and other properties of a Gas-to-Liquids (GTL) diesel fuel, ultra low sulphur EN590 reference diesel fuel, and a 50:50 blend of these two fuels are summarized in Table 1, 2 and 3. The GTL diesel used in the examples below was manufactured or derived by a Fischer Tropsch process.

### Example 1

A mini-fleet test was conducted using Gas-to-Liquids (GTL) diesel fuel, an ultra low sulphur EN590 reference diesel fuel, and a 50:50 blend of these two fuels. Three Mercedes Benz C220 CDI vehicles were used in the fleet test, each using one of the three test fuels. Several parameters were monitored periodically throughout the test, until all the vehicles had covered a minimum distance of 20 000 km.

One of these parameters was lubricant oil condition which was monitored by regular oil sample analysis during testing. The iron contamination results are shown in FIG. 1 and indicate that GTL exhibits significant wear reducing potential in its neat form and also when blended.

TABLE 1

| | | GTL | EN590 | 50/50 |
|---|---|---|---|---|
| | | Diesel | Diesel | GTL:EN590 |
| | | Fuel | Fuel | Blend |
| Density @ 20° C. | kg/l | 0.7734 | 0.8297 | 0.8029 |
| Dist D86 | | | | |
| IBP | ° C. | 174 | 180 | 175 |
| 5% | ° C. | 193 | 203 | 197 |
| 10% | ° C. | 202 | 212 | 206 |
| 20% | ° C. | 222 | 228 | 224 |
| 30% | ° C. | 242 | 244 | 243 |
| 40% | ° C. | 262 | 260 | 260 |
| 50% | ° C. | 280 | 276 | 278 |
| 60% | ° C. | 296 | 291 | 294 |
| 70% | ° C. | 312 | 305 | 309 |
| 80% | ° C. | 328 | 319 | 324 |
| 90% | ° C. | 345 | 334 | 342 |
| 95% | ° C. | 358 | 350 | 356 |
| FBP | ° C. | 367 | 371 | 367 |
| Flash point | ° C. | 57 | 60 | 59 |
| Viscosity @40° C. | cSt | 2.65 | 2.73 | 2.69 |
| CFPP | ° C. | −9 | −8 | −9 |
| Sulphur | mass % | 0.0001 | 0.0004 | 0.0003 |
| Cu corr. | | 1b | 1b | 1b |
| Acid number | mgKOH/g | 0.002 | 0.004 | 0.003 |
| Cetane | | 74.0 | 54.8 | 65.5 |
| O₂ stability | mg/100 ml | 0.2 | 0.5 | 0.3 |
| HFRR WSD | μm | 381 | 301 | 373 |

### Example 2

Two 1000 hour bench dynamometer tests were conducted using modern common rail passenger car diesel engines. GTL diesel was compared to a diesel that conformed to EN590 fuel specifications.

The GTL engine exhibited significantly lower wear rates, a 37% reduction in Fe contamination over EN590, as indicated by regular oil sample analyses, see FIG. 2, wherein iron contamination data from bench dynamometer endurance tests are shown.

The cylinder bores of all four cylinders of the two engines were measured using standard air-gauging techniques. This method yields repeatable bore diameter measurements to 1 micrometer accuracy. Since the cylinder bore wear had not been a primary area of interest for the project, baseline measurements were not conducted before the tests. In order to ascertain the cylinder bore wear, the bores were measured below the lower piston ring reversal area, and these measurements were used as the unworn baseline measurement for each cylinder, assuming perfect cylindricity. The bores of both engines showed significant visual evidence of polishing on the primary and secondary thrust surfaces. Comparison of the measured wear on the thrust axes of the cylinders of both engines revealed that the FT diesel engine wore 25% less than the EN590 engine. Results of the bore wear measurements are shown in FIG. 3, which shows a comparison of cylinder bore wear measurements on the thrust axes for the engines.

### Example 3

A bus fleet trial test was conducted in which twenty vehicles were selected and the test procedure was to run all 20 vehicles on a European EN590 diesel for a first oil drain interval of 15 000 km, after which 10 of the vehicles (the test group) were changed over to run on neat GTL diesel for two more oil drain intervals (equaling a distance of 30 000 km for each vehicle) while the remaining 10 vehicles (the control group) completed one more drain interval on EN590. The aim of this procedure was to set a baseline during the first test interval and then to provide direct comparisons between the GTL and EN590 fuels during the second and third test intervals.

TABLE 2

| Property | Units | GTL | EN590 |
|---|---|---|---|
| Density @ 20° C. | kg/l | 0.7698 | 0.8275 |
| Viscosity @ 40° C. | cSt | 2.46 | 2.34 |
| Total Sulphur | mg/kg | <1 | 4 |
| Total Aromatics | mass % | <0.1 | 23.1 |
| Mono-aromatics | mass % | <0.1 | 20.5 |
| Di-aromatics | mass % | <0.1 | 2.4 |
| Poly-aromatics | mass % | <0.1 | 0.2 |
| Distillation | | | |
| IBP | ° C. | 180 | 150 |
| 5% | ° C. | 201 | 190 |
| 10% | ° C. | 208 | 196 |
| 20% | ° C. | 219 | 207 |
| 30% | ° C. | 235 | 223 |
| 40% | ° C. | 251 | 242 |
| 50% | ° C. | 269 | 257 |
| 60% | ° C. | 286 | 272 |
| 70% | ° C. | 304 | 287 |
| 80% | ° C. | 323 | 303 |
| 90% | ° C. | 346 | 325 |
| 95% | ° C. | 363 | 344 |
| FBP | ° C. | 369 | 357 |
| Cetane Number | | >72 | 55 |
| Derived Cetane | | 82 | 56 |
| CFPP | ° C. | −5 | −22 |
| Lubricity (HFRR) | wsd, μm | 265 ± 80 | 340 ± 80 |
| Flash point | ° C. | 63 | 61 |

Throughout the trial, various measurements and assessments were done to evaluate GTL diesel's performance. These included regular lubricant oil analyses, which was recently revisited and shown to reveal a significant wear reducing effect when running on GTL diesel. A specific procedure of separating out the variable effects on wear rates and discarding obvious outlier data resulted in a linear regression, which showed the wear reducing effect of GTL diesel to be between 28 and 46% (as depicted by trend line slopes in FIG. 4). This manner of conducting the trial is particularly significant since it evidences that the reduction in wear is fuel specific.

It is also particularly significant since the bus engines did not make use of Exhaust Gas Recirculation (EGR) which is known to affect cylinder wear rates, especially where EGR is cooled. FIG. 4 depicts the iron levels normalised as they would be if all the bus engines and dust contamination were exactly the same.

TABLE 3

| Property | Unit | GTL | EN590 |
|---|---|---|---|
| Di Aromatic H/C | mass % | 0 | 4.87 |
| Mono Aromatic H/C | mass % | 0 | 20.44 |
| Poly Aromatic H/C | mass % | 0 | 4.870 |
| Total Aromatic H/C | mass % | 0 | 25.310 |
| Tri Aromatic H/C | mass % | 0 | 0 |
| Cetane Number | | 81.0 | 55.5 |
| CFPP | deg C. | −6 | −23 |
| Cloud Point | deg C. | −4.4 | −7.5 |
| Density @ 15 | kg/l | 0.7732 | 0.8311 |
| IBP | deg C. | 208.6 | 158.0 |
| 10% | deg C. | 222.0 | 194.8 |
| 20% | deg C. | 235.5 | 208.3 |
| 30% | deg C. | 251.0 | 226.0 |
| 40% | deg C. | 199.1 | 243.9 |
| 50% | deg C. | 267.6 | 259.6 |
| 60% | deg C. | 284.5 | 273.5 |
| 70% | deg C. | 301.1 | 287.8 |
| 80% | deg C. | 319.3 | 304.4 |
| 90% | deg C. | 340.2 | 327.0 |
| 95% | deg C. | 354.2 | 346.4 |
| FBP | deg C. | 362.5 | 358.5 |
| Flash Point | deg C. | 68 | 59 |
| Lubricity | WSD micrometre | 349 | 233 |
| Total Sulphur | mg/kg | <1 | 18 |

### Further Discussion of the Invention

Optical combustion studies comparing GTL and EN590 conducted on the Ricardo Hydra engine and the Combustion Bomb at the Sasol Advanced Fuels Laboratory (SAFL) were revisited for differences in flame position and luminosity, differences in convective and radiant heating of cylinder walls and possible subsequent oil film preservation differences. Images are shown in FIG. 5. In FIG. 5 comparative images of GTL and EN590 combustion in a constant volume bomb are depicted.

These images reveal a slightly increased level of flame luminosity and very slightly closer proximity of the flame to the walls in the case of the EN590 diesel fuel. The higher aromatic content of EN590 could cause a higher radiant heat transfer to the protective oil film on the cylinder wall of an engine resulting in reduced lubrication and higher wear.

Similar combustion image studies were conducted using image data taken from a quartz-piston C220 CDI engine. Images revealed similar differences in flame luminosity to the bomb experiments as well as decreased time of luminous burning in the GTL engine's combustion chamber. FIG. 6 shows the comparison at 41 degrees after TDC. In FIG. 6 comparative images of GTL and EN590 in quartz-piston engine at 41 degrees ATDC are depicted.

It will be appreciated that although various aspects of the invention have been described with respect to specific embodiments, alternatives and modifications will be apparent from the present disclosure, which are within the spirit and scope of the present invention.

Therefore, although the present invention has been described and illustrated as described with reference to the accompanying drawings, it is to be clearly understood that the same is by way of illustration and example only, and is not taken by way of limitation. The spirit and scope of the present invention are to be limited only by the terms of claims.

1. A method of operating a compression ignition engine with a Fischer-Tropsch derived fuel containing composition to reduce wearing of the engine cylinder walls compared to operating the engine with petroleum derived fuel, wherein the method reduces the iron contamination rate in engine oil by up to 46% compared to low sulphur petroleum derived diesel.

2. The method according to claim 1, wherein the compression ignition engine is provided with a compression ratio of greater than 14:1.

3. The method according to claim 2, wherein the compression ignition engine is provided with a compression of in excess of 16:1.

4. The method according to claim 2, wherein the compression ratio of the engine is 18:1.

5. The method according to claim 1, wherein the compression ignition engine is turbocharged at a boost of from 0 to 2 bar above atmosphere.

6. The method according to claim 5, wherein the compression ignition engine is turbocharged at a boost of from 0 to 1.5 bar above atmosphere.

7. The method according to claim 1, wherein the engine is operating at an oil temperature which is between 30 degC and 150 degC.

8. The method according to claim 7, wherein the engine is operating at an oil temperature which is between 40 and 130 degC.

9. The method according to claim 1, wherein the fuel composition includes from 1 vol % to 100 vol % Fischer Tropsch fuel.

10. The method according to claim 1, wherein the fuel composition includes from 50 vol % to 100 vol % Fischer Tropsch fuel.

11. The method according to claim 1, wherein the Fischer-Tropsch fuel has less than 0.1 mass % aromatics.

12. The method according to claim 1, wherein the Fischer-Tropsch fuel has less than 0.1 mass % sulphur.

13. The method according to claim 12, wherein the Fisher-Tropsch fuel has less than 0.001 mass % sulphur.

14. The method according to claim 1, wherein the Fischer-Tropsch fuel has cetane above 65.

15. The method according to claim 1, wherein the Fischer-Tropsch fuel has a density below 0.8 kg/l.

16. The method according to claim 1, wherein the fuel composition has a lower flame luminosity than petroleum derived low sulphur diesel when combusted in a CI engine.

17. The method according to claim 1 wherein the fuel composition reduces the amount of soot loading in the engine oil when compared to the engine operating on petroleum derived fuel.

18. (canceled)

19. The method according to claim 1, wherein the method reduces the iron contamination rate in engine oil by 37% compared to low sulphur petroleum derived diesel.

20. The method according to claim 1, wherein the method reduces the iron contamination rate in engine oil by 22% compared to low sulphur petroleum derived diesel.

21. The method according to claim 1, wherein the method reduces iron contamination rate in engine oil by between 22 to 46% compared to low sulphur petroleum derived diesel fuel.

22. (canceled)
